(19) United States
(12) Patent Application Publication
(10) Pub. No.: US 2024/0191824 A1
(43) Pub. Date: Jun. 13, 2024

(54) ACTUATOR SYSTEM HAVING A MODULAR FIXATION

(71) Applicant: BELIMO Holding AG, Hinwil (CH)

(72) Inventors: Urs NIEDERHAUSER, Pfungen (CH); Patrick SCHMIDHEINY, Wetzikon (CH)

(21) Appl. No.: 18/555,374

(22) PCT Filed: Apr. 10, 2022
(86) PCT No.: PCT/EP2022/059553

§ 371 Date: Oct. 13, 2023

(30) Foreign Application Priority Data
Apr. 13, 2021 (CH) 00378/21

(51) Int. Cl. F16L 55/07; F16K 1/22; F16K 27/02; F16K 31/04

(52) U.S. Cl. CPC F16L 55/07; F16K 1/221; F16K 31/042; F16K 27/0218

(57) ABSTRACT

An actuator system is provided for operating a flow regulating element, e. g. a flap or a valve shutter for regulating a fluid flow in a fluid transportation pipe. The actuator system may include an actuator having an actuating motor coupled to a pivotable shaft of the flow regulating element which projects from the wall of the pipe. The actuator system has an attachment component for attachment of the attachment component to the wall of the fluid transportation pipe. The actuator and the attachment component are configured as a modular system.

### TECHNICAL FIELD

The present disclosure relates to an actuator system for operating at least one flow regulating element to regulate a fluid flow of a fluid transportation pipe.

### BACKGROUND

In the field of heating, ventilation and air-conditioning systems, called HVAC systems, in buildings, in particular residential buildings, office buildings, commercial buildings and industrial buildings, automatic fluid flow regulation has become more and more important. To this end, a plurality of sensors and actuators for regulating the flow are used, controlled by automatic centrally or decentrally arranged control devices. Actuating motors, sensors, like pressure sensors and temperature sensors, and regulators are usually combined in one compact unit.

Pivotable fluid regulating elements, like shutters or flaps, are important components for automatic fluid flow control systems. The volumetric flow is measured using a suitable sensor, and the measured values are forwarded to an electronics system. In order to pivot the fluid regulating elements, actuator motors operate the flow regulating elements. Due to relatively high torque generated in this process the connection between the actuators and the respective fluid pipe has to be strong and reliable. Particularly, the actuating motor has to be prevented from twisting on account of the exerted torque. On the other hand, mounting the actuator to the pipe has to be kept as simple as possible. Furthermore, when the motor is firmly coupled to a fluid regulating element, it may be necessary to absorb, in addition to a torque, any eccentricity of the rotating shaft axis.

The U.S. Pat. No. 8,061,684 B2 discloses an anti-twist device which permits a corresponding linear movement in the longitudinal direction but prevents twisting of the actuating motor. However, mounting the actuator to a pipe is still complex, and the actuators as well as the attachment components have to be adapted to each other specifically.

### SUMMARY

It is an object of the present disclosure to provide an actuator system for operating at least one flow regulating element to regulate a fluid flow of a fluid transportation pipe, and a method of mounting such a device, which provide a secure and reliable connection between the actuator system and the pipe, while reducing the complexity of the mounting process. An actuator system for operating at least one flow regulating element, e.g. a flap, a valve shutter, etc., to regulate a fluid flow of a fluid transportation pipe according to the present disclosure, comprises: an actuator having an actuating motor coupled to a pivotable shaft of the flow regulating element of the fluid transportation pipe, and an actuator housing, wherein the actuating motor is connected to the actuator housing; at least one attachment component for attachment of the attachment component to a wall of the fluid transportation pipe; wherein the actuator housing comprises a connecting port for connecting the attachment component to the housing.

Particularly, the actuator system is a modular system comprising the actuator and at least one of the attachment components. Conventional actuators and gearboxes differ in their size and configuration, e. g. in the size of the base plate and the configuration of the housing. Therefore, a large variety of actuator systems for fluid control are available, all of them having different and even customer specific attachment systems for fixing them to the place of installation, e. g. a fluid pipe. Providing attachment components and the actuator as separate, modular components reduces the variety of connection concepts as well as variants of the base module.

This disclosure proposes a simplified mounting process, namely, mounting a fixing element like a screw to the pipe, then fixing the actuator and the attachment element, which is adapted to both the fixing element and the actuator housing, to the pre-mounted fixing element. This provides that no more accessories (e. g. anti-twist devices, further screws) are required that could be lost during the mounting process. In a particular embodiment of the present disclosure the fixing element may be pre-mounted.

Another advantage is that the solution is backwards compatible and still works with existing anti-rotation devices.

It is preferred that the attachment component is detachably fixed to the connection port of the housing.

In a preferred embodiment of the present disclosure the attachment component is connectable to the connecting port by a clamping connection. The attachment component connectable to the connecting port by a clamping connection may be snapped into place and then fixed to pre-mounted fixing elements (e. g. screws) already pre-mounted in the place of installation.

The clamping connection may comprise at least two flexible arms to be insertable in corresponding receptacles of the connecting port.

It is preferred that the system comprises a locking element for locking the connection between the connecting port and the attachment component. Particularly, the locking element may be inserted in a space between the clamping arms to prevent movement of engagement lugs of the clamping arms within corresponding clamping grooves provided in the port of the housing.

In a particular embodiment the attachment component comprises a slot for receiving a fixing element which is fixed in a wall of the fluid transportation pipe. The fixing element may be a screw, a bolt or any other stud that can be mounted, especially pre-mounted, in the wall of the pipe. The attachment component comprising a longitudinal slot or clearance that may be open at one end of the slot and clearance, respectively, is particularly useful for applications wherein the actuator system has to absorb or compensate for eccentricity of the rotation of the shaft of the flow regulating element. The slot allows the housing to move (linearly) along a longitudinal axis relative to the pipe, and therefore tensions in the attachment components (or other components of the system) can be avoided. In other words, even in case of an eccentricity of the rotating shaft of the fluid flow regulating element eccentricity can be compensated for. The degree of eccentricity depends on the diameter of the rotating shaft which is mounted to a universal adapter that can accommodate multiple diameters. The smaller the diameter the greater the eccentricity will be. Unprecise mounting may be another source for eccentricity.

In this case, one side of the actuator is fixed with play to allow longitudinal movement, but the attachment element prevents rotation around the shaft of the fluid regulating element. Furthermore, this construction allows assembly of an actuator to a pipe in short time, as only one screw that is already pre-assembled, is involved. Thus, installation is much easier, even overhead.

The attachment component may comprise a fixing portion to be inserted in a bore provided in the wall of the fluid transportation pipe at a distance from the pivotable shaft of the flow regulating element. In this embodiment, the attachment component has a fixing portion integrally formed or fixed thereto, which replaces the separate fixing element. The fixing portion may e.g. be a bolt or a spring element extending from the body of the attachment component towards the wall of the pipe. In the mounting process, a bore could be formed in the pipe before fixing the actuator system to the pipe. Also in these embodiments the number of components is small and mounting even with just one hand is possible.

The actuator system may comprise a fixing element to be fixed to the wall of the fluid transportation pipe at a distance from the pivotable shaft of the flow regulating element. The distance is suitably selected such that the fixing element can project through a hole or a slot of the attachment component. The fixing element may comprise a screw and/or a bolt which is insertable in the slot of the attachment component or projects through a bore of the attachment component. Particularly, in case there is a slot, the fixing element is arranged approximately in the middle of the slot.

In a preferred embodiment of the present disclosure the fixing element comprises a sleeve which is attached to the screw and bolt, respectively. Providing a sleeve has the effect that the assembly process is improved. While, when there was an eccentricity caused by different diameters of the shaft and a clamp, the eccentricity could be compensated only by installing the anti-rotation device with play in the slot so that the system would not jam. This is error-prone and a relatively laborious assembly step. To simplify this assembly step, it is optimized by the sleeve with the pre-assembled screw so that this is much easier and no incorrect assembly is possible. As a result, a centric clamping block is no longer necessary. Furthermore, the sleeve helps when pre-mounting the fixing element as it functions as a spacer indicating how deep the fixing element may be fixed in the wall of the pipe.

It is preferred that the attachment component is provided for at least preventing rotation of the housing around an axis of rotation of the pivotable shaft.

In another embodiment of the present disclosure the attachment component is provided for allowing movement of the housing along a longitudinal axis of the fluid transportation pipe.

In another embodiment of the present disclosure the actuator system comprises at least two attachment components and the housing comprises at least two corresponding connecting ports. This embodiment is particularly useful if there is no eccentricity, e.g. due to the fact that the drive is mounted via a form-fit (positive locking) which does not lock the shaft in a vertical direction connection or via an interlock. Then the actuating motor only has to absorb the torque, but not any eccentricity. The interlock is virtually always central relative to the drive shaft of the shut-off flap. The housing of the actuating motor is screwed to the pipe and thus prevents the system from rotating with the shaft. Moreover, the actuating motor is secured in the axial direction of the drive shaft. No longitudinal play is required as for embodiments described above.

Furthermore, if eccentricity is no issue, both sides of the actuator can be equipped with an attachment component, particularly with the same kind, that are fixedly mounted to the pipe to prevent (longitudinal) axial play and rotation.

The object is also achieved by providing a method for assembling an actuator system as described above, comprising the steps: pre-mounting the fixing element at a distance from the pivotable shaft, wherein the distance is adjusted such that, when the actuating motor is coupled to the pivotable shaft, the fixing element is positioned in the slot of the attachment component.

It is preferred that the fixing element is positioned substantially in the middle of the slot of the attachment component.

The present disclosure relates to any combination of any features described in this application.

### BRIEF DESCRIPTION OF THE DRAWINGS

The present disclosure will be explained in greater detail with reference to the exemplary embodiments which are illustrated in the drawings.

FIG. 1 is a perspective view of a first embodiment of an actuator system according to the present disclosure in a mounted state;

FIG. 2 is a perspective view of a detail of the first embodiment of the present disclosure in an unmounted state;

FIG. 3 is a top sectional view of a detail the first embodiment of the present disclosure in a mounted state;

FIG. 4 is a perspective view of a detail of a second embodiment of the present disclosure in an unmounted state;

FIG. 5 is a top sectional view of a detail of a second embodiment of the present disclosure in a mounted state;

FIG. 6 is a perspective view of the second embodiment of the present disclosure in a mounted state; and

FIG. 7 illustrates perspective views of a component of a third embodiment of the present disclosure.

### DETAILED DESCRIPTION

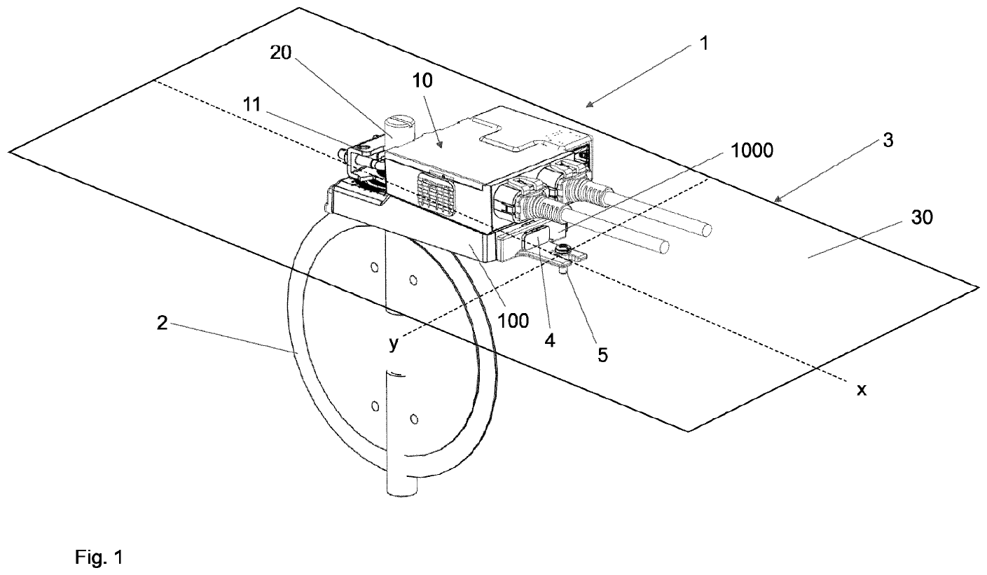

FIG. 1 illustrates a first embodiment of an actuator system 1 according to the present disclosure for operating a flow regulating element, e. g. a flap or a valve shutter 2 (implied in the drawing, although not visible), for regulating a fluid flow in a fluid transportation pipe 3. In this embodiment the transportation pipe 3 forms an air flow channel.

The actuator system 1 comprises an actuator 10 having an actuating motor coupled to a pivotable shaft 20 of the flow regulating element 2 which projects from the wall 30 of the pipe 3. The actuating motor may have a step-down gear mechanism to rotate the shaft 20 exactly in a predefined angle. The coupling can e. g. be accomplished via a positive or a non-positive fit, e. g. by clamping. The actuator 10 has an actuator housing 100, wherein the actuating motor is accommodated.

Furthermore, the actuator system 1 comprises an attachment component 4 for attachment of the attachment component 4 to a wall 30 of the fluid transportation pipe 3. The actuator housing 100 comprises a connecting port 1000 for connecting the attachment component 4 to the housing 100. The actuator 10 and the attachment component 4 are configured as modular system 1.

The regulating element 2 is arranged within the pipe 3. It is connected or formed integrally with a shaft 20 that extends through the wall 30 of the pipe 3. The shaft 20 is fixed to and coupled with the motor of the actuator 10 such that the actuator 10 is capable of rotating the shaft 20. The motor may be axially coupled with the shaft 20 by a clamping connection 11. However, this connection may not be perfectly axial, but it may have an eccentricity which depends on the shaft diameter, when the shaft 20 is fixed by a universal clamping connection 11 suitable for fixing various shaft diameters. Therefore, the housing may move along a longitudinal axis x of the pipe 3 when the shaft 20 is rotated by the motor of the actuator 10.

The attachment component 4 is attached to the housing 100 via the connecting port 1010, and it is connected to the wall 30 of the pipe 3 by means of a self-tapping screw 5.

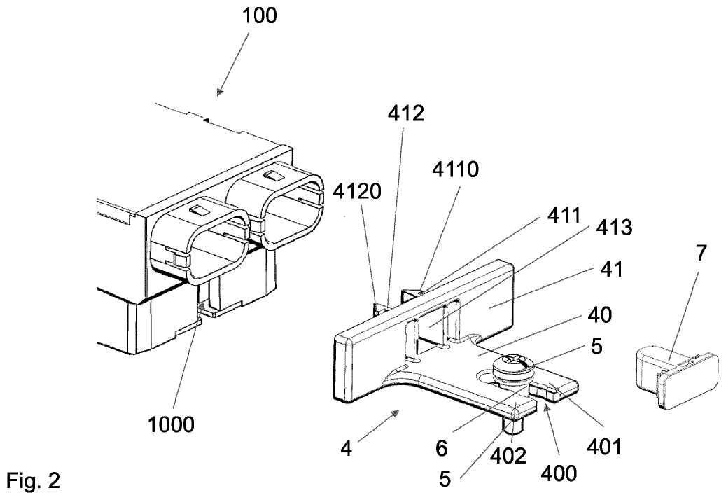

FIG. 2 illustrates details of the attachment component 4 of the first embodiment of the present disclosure and of the connection between the attachment component 4 and the housing 100.

The attachment component 4 is made of plastics, but it could be made of any other suitable material like sheet metal. It has a first connection portion 40 for connecting to the wall 30 of the pipe 3. The first connection portion 40 is arranged on the surface of the wall 30 of the pipe 3. In a mounting process a screw 5 may be screwed in the wall 30 of the pipe 3 before the actuator system 1 is fixed to the pipe 3, or the screw may be fixed to the wall 30 after arranging the actuator system 1. Thus the system 1 can be mounted to the pipe 3 by a person using just one hand.

The screw 5 is provided with a sleeve 6 which is attached to the screw 5. The sleeve 6 has the function of a spacer. It delimits the depth of screwing the screw 5 into the pipe 3 and prevents that the screw 5 is screwed in too deep.

The first connection portion 40 has a longitudinal slot 400 formed therein. The shaft 50 of the pre-fixed screw 5 extends through the slot 400. The slot 400 is defined by a first arm 401 of the first connection portion 40 and a second arm 402 of the first connection portion 40. The screw 5 is arranged about in the middle of the x-extension of the slot 400 (see FIG. 1). This arrangement allows the attachment component 4 to move relative to the pipe 3 along a longitudinal axis x.

The second connection portion 41 of the attachment component 4 is provided for attaching the component 4 to the housing 100 of the actuator 10. Therefore, the second connection portion 41 comprises a body 410 which extends in an angle of about 90° from the first connection portion 40, and two engagement arms 411 and 412 for engagement with the connecting port 1000 provided in the housing 100. The arms 411 and 412 extend parallel to and to the opposite side of the first connection portion 41. The arms 411 and 412 are at least partially elastic and have an outwardly extending engagement protrusion 4110 and 4120 for engagement with corresponding recesses (not shown) formed in the connection port 1000.

When mounting the system 1 to the pipe 3, the screw 5 carrying the sleeve 6 is screwed into the wall 30 of the pipe 3. Afterwards, the slot 400 of the attachment component 4 is fixed to the screw by pushing the attachment component 4 such that the screw 5 is inserted into the slot 400. When the attachment component 4 is in the correct position, the actuator housing 100 is connected to the attachment component 4 by inserting the engagement arms 411 and 412 of the attachment component 4 into the connection port 1000 of the housing of the actuator 10. Afterwards, a locking element 7 may be inserted through an opening 413 formed in the body 410 of the second connection portion 41 between the arms 411 and 412. The locking element 7 blocks the arms 411 and 412 and prevents the attachment component 4 from disengaging from the connection port 1000.

The steps of fixing the attachment component 4 to the housing 100 and the pipe 3, respectively, can be carried out in different order.

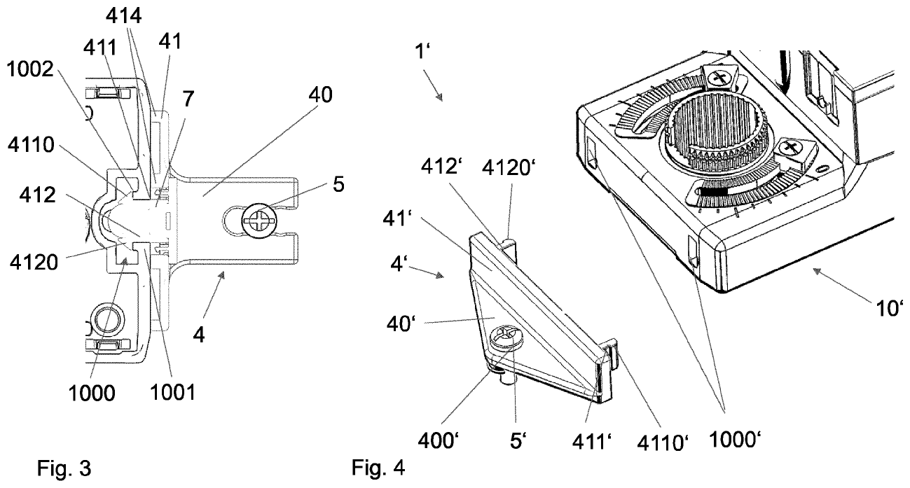

FIG. 3 is a sectional top view of the connection between the housing 100 and the attachment component 4, wherein the same reference numbers are used. In this view it can be seen that the attachment component comprises support protrusions 414 (two of them being marked exemplary) for supporting the attachment component 4 in a correct position relative to the housing 100. Furthermore, the recesses 1001 and 1002 for engagement of the engagement protrusions (latching lugs) 4110 and 4120, and the blocking function of the locking element 7 can be seen.

The attachment component 4 and the screw 5 align and keep the actuator 10 in a predetermined longitudinal orientation, i. e. rotation of the actuator 10 in a plane x-y (see FIG. 1) and/or rotation of the actuator 10 around the shaft 20 of the regulating element 2 is prevented, while compensating eccentric alignment of the shaft 20 relative to the actuator 10. In fact, any eccentricity caused by the fit between the actuator motor and the shaft 20 can be compensated for without problems at any time when the drive shaft 20 is rotated.

FIG. 4 illustrates a second embodiment of the modular system 1′ of the present disclosure. Corresponding components have the same reference numbers with apostrophe as in the first embodiment.

FIG. 4 shows a detail of the system 1′ having an actuator 10′ and two attachment components 4′ (only one attachment component is shown in FIG. 4), one for each side of the actuator 10′. In this embodiment the shaft is only coupled to transfer the rotary movement, but the system 1 is not fixed to the duct/shaft 3 along the shaft axis (e.g. by clamping) like in the first embodiment, thus two attachment components are needed.

The actuator 10′ comprises a connection port 1000′ for engagement of engagement arms 411′ and 412′ of the attachment component 4′. The attachment component 4′ differs from the attachment component 4 of the first embodiment in that it does not comprise a slot formed in the first connection portion 40′, but a through hole 400′ for insertion of a screw 5′.

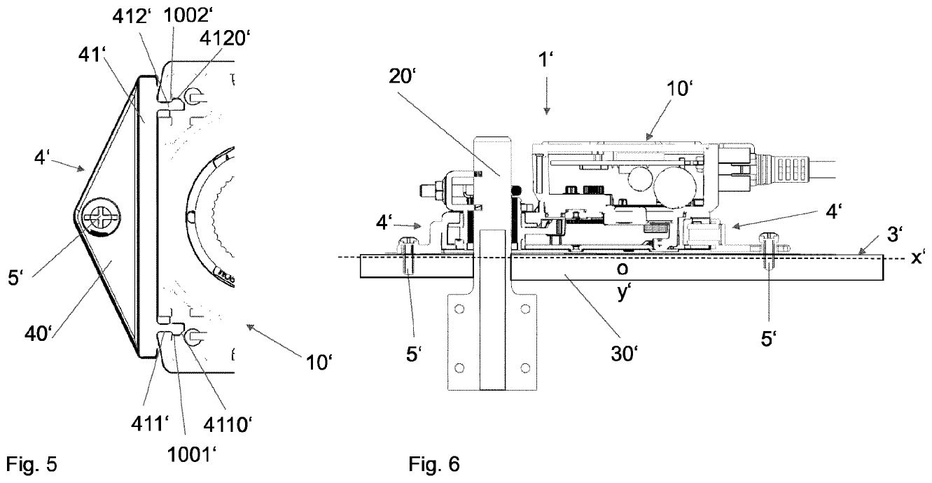

FIG. 5 is a sectional top view of the second embodiment of the present disclosure in a mounted state with engagement protrusions 4110′ and 4120′ engaging the recesses 1001′ and 1002′, respectively, of the connection port 1000′.

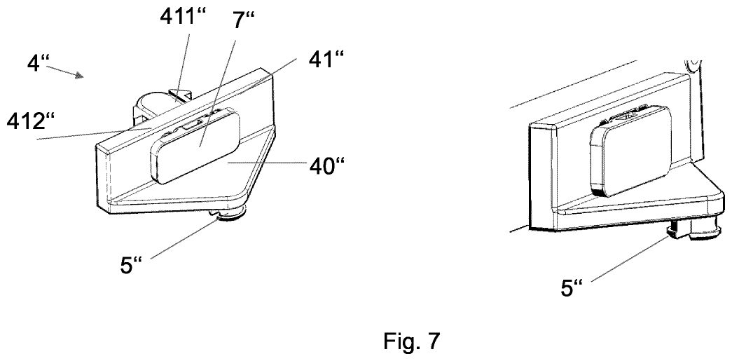

FIG. 6 is a longitudinal sectional view of the complete system 1′ of the second embodiment mounted to the wall 30′ of a pipe 3′. The drawing shows that the actuator 10′ is mounted to the pipe 3′ at each of the longitudinal ends by a respective attachment component 4′ which are fixed to the wall 30′ of the pipe 3′ by respective screws 5′. It can be seen that the actuator 10′ is not moveable along the axis x′, i. e. the system 1′ is provided for the case that no eccentricity occurs that has to be compensated when the shaft 20′ of the regulating element is rotated. The system 1′ is fixed to the pipe 3′ in at least x′ and y′ extension.

Assembling an actuator system 1 or 1′ of any of the embodiments includes pre-mounting the fixing element 5, 5′ in a predetermined distance from the pivotable shaft 20, 20′, wherein the distance is adjusted such that, when the actuating motor is coupled to the pivotable shaft 20, 20′, the fixing element 5, 5′ engages the slot 400 and through hole 400′, respectively, of the attachment component 4, 4′.

FIG. 7 refers to a third embodiment of the attachment component 4″. Compared to the first and the second embodiments the attachment component 4″ comprises, instead of a through hole for a screw, a spring element 5″ or an attachment protrusion which extends from the bottom surface (facing the pipe) of the first connection portion 40″. When fixing the attachment component 4″ to the pipe, the spring element or attachment protrusion 5″ is latched, inserted or engaged in a corresponding blind hole (not shown) formed in the wall of the pipe. Furthermore, attachment component 4″ has a locking element 7″ for locking the attachment component 4″ to the housing of the actuator, similar to the first embodiment.

1. An actuator system for operating a flow regulating element to regulate a fluid flow of a fluid transportation pipe, the actuator system comprising:
an actuator having an actuating motor coupled to a pivotable shaft of the flow regulating element, and an actuator housing, wherein the actuating motor is connected to the actuator housing;
at least one attachment component for attachment of the attachment component to a wall of the fluid transportation pipe;
wherein the actuator housing comprises a connecting port for connecting said configured to connect the attachment component to the housing.

2. The actuator system according to claim 1, wherein the actuator system is a modular system comprising the actuator and at least one of the attachment components.

3. The actuator system according to claim 1, wherein the attachment component is detachably fixed to the connection port of the housing.

4. The actuator system according to claim 1, wherein the attachment component is connectable to the connecting port by a clamping connection.

5. The actuator system of claim 4, wherein the clamping connection comprises at least two flexible arms configured to be insertable in corresponding receptacles of the connecting port.

6. The actuator system according to claim 1, wherein the system comprises a locking element configured to lock the connection between the connecting port and the attachment component.

7. The actuator system according to claim 1, wherein the attachment component comprises a slot configured to receive a fixing element which is fixed in a wall of the fluid transportation pipe.

8. The actuator system according to claim 1, wherein the attachment component comprises a fixing portion configured to be inserted in a bore provided in the wall of the fluid transportation pipe at a distance from the pivotable shaft of said the flow regulating element.

9. The actuator system according to claim 1, wherein the system comprises a fixing element configured to be fixed in a wall of the fluid transportation pipe at a distance from the pivotable shaft of the flow regulating element.

10. The actuator system of claim 9, wherein the fixing element comprises a screw and/or a bolt which is insertable in a slot of the attachment component.

11. The actuator system of claim 10, wherein the fixing element comprises a sleeve which is attached to the screw and/or the bolt.

12. The actuator system according to claim 1, wherein the attachment component is configured to at least prevent rotation of the housing around an axis of rotation of the pivotable shaft.

13. The actuator system according to claim 1, wherein the attachment component is configured to allow movement of the housing along a longitudinal axis of the fluid transportation pipe.

14. The actuator system according to claim 1, wherein the system comprises at least two attachment components and the housing comprises at least two corresponding connecting ports.

15. A method for assembling an actuator system according to claim 9, the method comprising:
mounting the fixing element at a distance from the pivotable shaft, wherein the distance is adjusted such that, when the actuating motor is coupled to the pivotable shaft, the fixing element is positioned in a slot of the attachment component.

16. The method of claim 15, wherein the fixing element is positioned substantially in the middle of the slot of the attachment component.
